(19) United States
(12) Patent Application Publication
(10) Pub. No.: US 2007/0065200 A1
(43) Pub. Date: Mar. 22, 2007

(54) Image forming apparatus with image registration adjustment

(76) Inventor: Yohichi Asaba, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/522,341

(22) Filed: Sep. 18, 2006

(30) Foreign Application Priority Data
Sep. 16, 2005 (JP) JP2005-270866
May 22, 2006 (JP) JP2006-141285

(51) Int. Cl. G03G 15/00

(52) U.S. Cl. 399/394; 399/401

(57) ABSTRACT

An image forming apparatus for double-sided image forming includes an image forming mechanism configured to form an image on a recording medium, a re-feeding mechanism configured to re-feed a recording medium having an image formed on a first side thereof to the image forming mechanism, an adjustment mechanism configured to be able to adjust a relative position between a recording medium and an image, and a control mechanism configured to control the adjustment mechanism according to a first correction value derived by subtracting an actual image position on a second side of a recording medium from a predetermined position when second-side image forming is performed after first-side image forming is performed. The actual image position of the second side of the recording medium is obtained by forming a reference image thereon.

### CROSS REFERENCE TO RELATED APPLICATIONS

This application claims priority from JP 2005-270866 filed Sep. 16, 2005 and JP 2006-141285 filed May 22, 2006 both of which are incorporated herein by reference.

### BACKGROUND OF THE INVENTION

1) Field of Invention

Exemplary aspects of the present invention relate to an image forming apparatus, such as a copier and a printer, and to an image forming apparatus for effectively enhancing a registration quality of image forming.

2) Description of Related Art

A related art image forming apparatus, such as a copier, a printer, and a facsimile machine includes a plurality of sheet feeding trays such as sheet feeding cassettes and trays. In the related art image forming apparatus, the plurality of sheet feeding trays have respective positioning tolerances, and skew, which may occur during sheet conveyance, varies with the sheet feeding trays. When the related art image forming apparatus performs image forming on sheets fed from the respective sheet feeding trays, the positioning tolerances and skew may result in tray-to-tray variations in image forming positions on the sheets. As a result, variations in margins are observed on the sheets. In a worse case, an image may be transferred off an edge of a sheet.

Recently, an increasing number of double-sided image forming apparatuses have been in use for such reasons as energy-saving and environmental protection. A double-sided image forming apparatus refers to an image forming apparatus capable of forming respective images on two sides of a sheet. When performing double-sided image forming, a related art double-sided image forming apparatus forms an image on a first side of a sheet, and then reverses a sheet so that another image may be formed on a second side thereof. Reversing a sheet in double-sided image forming may cause image forming positions to vary with sides of the sheet. As a result, side-to-side variations in margins are observed on the sheet. In a worse case, an image formed on a side of a sheet may be positioned off an edge of the sheet.

In a related art image forming apparatus including a plurality of sheet feeding trays, an image forming position is adjustable for each of the plurality of sheet feeding trays, and one of the plurality of sheet feeding trays is used for feeding a sheet for double-sided image forming.

In another related art that performs double-sided image forming, an image forming apparatus is configured such that a scaling factor and timing of starting outputting print data for each color are changeable for each side of a sheet when double-sided image forming is performed.

In another related art, an image forming apparatus is capable of preventing displacement of registration for each side of a sheet.

### SUMMARY

An image forming apparatus for double-sided image forming of an exemplary aspect of the invention includes an image forming mechanism configured to form an image on a recording medium. A re-feeding mechanism is configured to re-feed a recording medium having an image formed on a first side thereof to the image forming mechanism. An adjustment mechanism is configured to be able to adjust a relative position between a recording medium and an image, and a control mechanism is configured to control the adjustment mechanism according to a first correction value derived by subtracting an actual image position on a second side of a recording medium from a predetermined position when second-side image forming is performed after first-side image forming is performed. The actual image position of the second side of the recording medium is obtained by forming a reference image thereon.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a cross section view illustrating an outline of a full color printer according to one exemplary embodiment of the present invention;

FIG. 2 is an illustration of a sheet conveyance path in the full color printer shown in FIG. 1;

FIGS. 3A, 3B, 3C, and 3D are schematic illustrations for explaining exemplary variations in image forming positions;

FIG. 4 is a block diagram illustrating a part of a configuration of a control mechanism of the full color printer shown in FIG. 1 related to an adjustment of an image forming position;

FIG. 5 is a flowchart of an exemplary detailed operation in image forming performed by the full color printer shown in FIG. 1; and

FIGS. 6A, 6B, 6C, and 6D are schematic illustrations for explaining exemplary image forming positions in double-sided image forming corrected by the full color printer shown in FIG. 1.

### DETAILED DESCRIPTION OF EXEMPLARY EMBODIMENTS

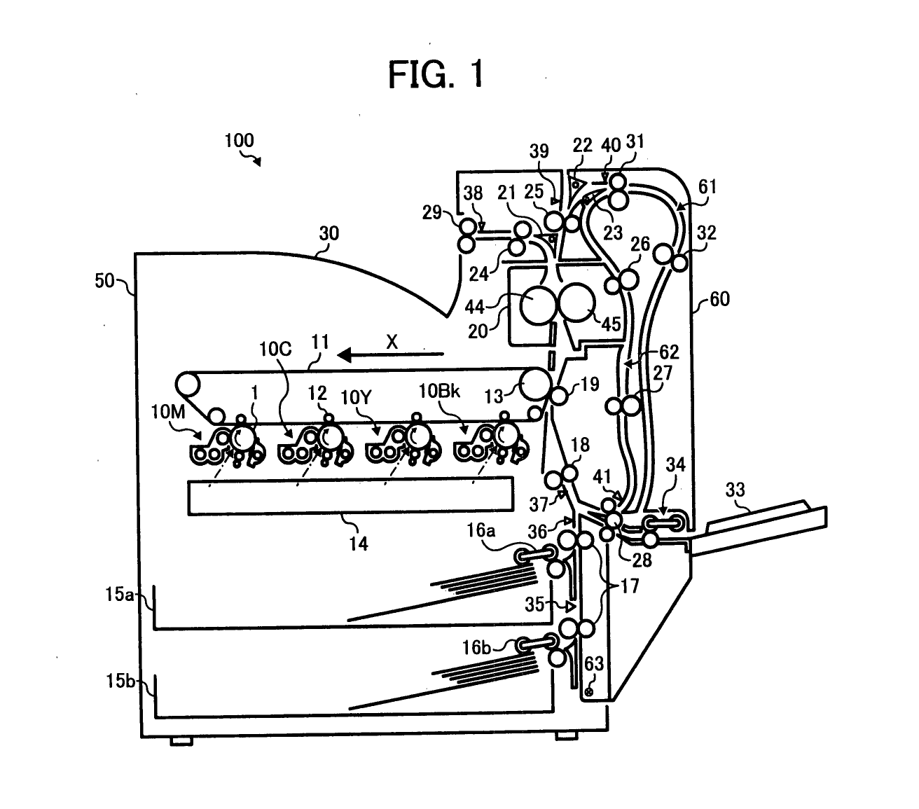

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIG. 1, a full color printer according to an exemplary embodiment of the present invention is described.

A general configuration of a full color printer representing an example of an image forming apparatus according to an exemplary embodiment of the present invention is described below.

As shown in FIG. 1, a full color printer 100 includes a body 50. In a central part of the body 50, the full color printer 100 includes an intermediate transfer belt 11 and four image forming units 10M, 10C, 10Y, and 10Bk (collectively referred to as image forming units 10), and an optical writing unit 14. The full color printer 100 further includes a transfer opposing roller 13 and a secondary transfer roller 19. The image forming units 10 include respective photoconductor drums 1 and transfer rollers 12. The image forming units 10 further include respective charge mechanisms, development units, cleaning mechanisms, and so forth arranged around the respective photoconductor drums 1.

In a lower part of the body 50, the full color printer 100 includes sheet feeding cassettes 15a and 15b, two pairs of conveyance rollers 17, a pair of registration rollers 18, and a secondary transfer unit having a secondary transfer mechanism. The sheet feeding cassettes 15a and 15b are provided with sheet feeding mechanisms 16a and 16b, respectively. Each of the sheet feeding mechanisms 16a and 16b includes a call roller, a supply roller, and a separation roller.

In an upper part of the body 50, the full color printer 100 includes a fixing unit 20, first, second, and third switch pawls 21, 22, and 23, and pairs of conveyance rollers 24, 25, 26, and 27. The full color printer 100 further includes a pair of sheet discharge rollers 29, a sheet discharge tray 30, and sheet sensors 35, 36, 37, 38, 39, 40, and 41. The fixing unit 20 includes a fixing (heating) roller 44 and a pressing roller 45.

In a side part of the body 50, the full color printer 100 includes a sheet re-feeding roller 28, a manual sheet feeding tray 33, a sheet feeding mechanism 34, and a duplex unit 60. The sheet re-feeding roller 28 is provided with two driven rollers. The duplex unit 60 includes a switchback conveyance path 61 and a sheet re-feeding path 62. The duplex unit 60 further includes a pair of first reverse rollers 31, and a pair of second reverse rollers 32. The sheet feeding mechanism 34 includes a call roller, a supply roller, and a separation roller.

In the central part of the body 50, the intermediate transfer belt 11 is wound around a plurality of rollers including the transfer opposing roller 13. The image forming units 10 are arranged along a travel edge on a lower side of the intermediate transfer belt 11. The transfer rollers 12, which serve as a primary transfer mechanism, are provided inside the intermediate transfer belt 11 at respective positions opposed to the respective photoconductor drums 1. In the full color printer 100, the four image forming units 10 share the same configuration except for colors of developers used in the respective development units therein, including magenta, cyan, yellow, and black. In the full color printer 100, the four image forming units 10 are arranged in the order of magenta, cyan, yellow, and black from a left side in FIG. 1. Each of the image forming units 10 is provided as a process cartridge attachable to and detachable from the body 50 of the full color printer 100. The optical writing unit 14 is arranged below the image forming units 10. The optical writing unit 14 includes a polygon mirror and a set of mirrors (not shown), and irradiates surfaces of the photoconductor drums 1 in the respective image forming units 10 with optically modulated laser light. The laser light scans the surfaces of the photoconductor drums 1 in a main scanning direction which is perpendicular to a sheet conveyance direction. Although the optical writing unit 14 may be individually provided to each of the image forming units 10, sharing the single optical writing unit 14 is advantageous in terms of cost. In the exemplary embodiment, the intermediate transfer belt 11 and the optical writing unit 14 are provided as units, and are configured to be attachable to and detachable from the body 50 of the full color printer 100. The secondary transfer roller 19 is located above the pair of registration rollers 18 at a position opposing to the transfer opposing roller 13, and serves as the secondary transfer unit.

In the lower part of the body 50, the sheet feeding cassettes 15a and 15b are arranged in respective tiers. The pairs of conveyance rollers 17 convey a recording medium, such as a transfer sheet (hereinafter referred to as a sheet) fed by the sheet feeding mechanisms 16a and 16b. Further, the pair of registration rollers 18 is located above the upper one of the pairs of conveyance rollers 17 (located downstream in the sheet conveyance direction).

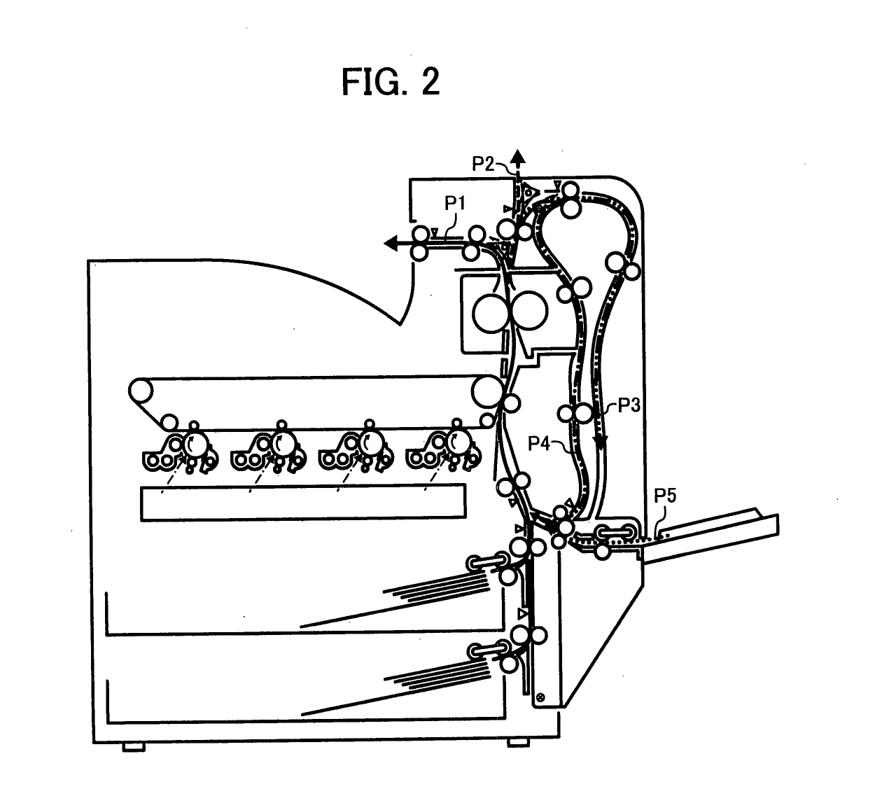

Further, the fixing unit 20 is located above the secondary transfer unit. The first, second, third switch pawls 21 to 23 are arranged above the fixing unit 20, and switch sheet conveyance directions. As shown in FIG. 2 by solid lines and dotted lines, respective positions of the first, second, and third switch pawls 21 to 23 are switched by using respective actuators, such as solenoid actuators (not shown). The pairs of conveyance rollers 24 to 27, and the sheet sensors 35 to 41 are properly arranged on sheet conveyance paths. The sheet conveyance paths are properly guided by guide members, such as a guide plate. The sheet discharge tray 30 is formed by an upper face of the body 50. The pair of sheet discharge rollers 29 is located at upper left of the fixing unit 20, and discharges a sheet onto the sheet discharge tray 30.

In the side part of the body 50, the pair of first reverse rollers 31 is located in an entry part of the switchback conveyance path 61 arranged in the upper area of the body 50. The pair of second reverse rollers 32 is located in midstream of the switchback conveyance path 61. The pairs of first and second reverse rollers 31 and 32 are configured to be able to rotate in forward and backward directions. The sheet re-feeding path 62 is substantially trisected by the pairs of conveyance rollers 26 and 27. The third switch pawl 23 is arranged immediately next to the pair of first reverse rollers 31, and is located in an area where a sheet carried out of the switchback conveyance path 61 is conveyed into the sheet re-feeding path 62.

The manual sheet feeding tray 33 is arranged on a side face of the duplex unit 60, and may be pulled out of the duplex unit 60 and be retracted into the duplex unit 60. FIG. 1 shows the full color printer 100 with the manual sheet feeding tray 33 pulled out. The sheet feeding mechanism 34 feeds a sheet from the manual sheet feeding tray 33. The sheet re-feeding roller 28 is medially arranged at a side of the sheet feeding mechanism 34. The driven rollers are press-contacted with upper and lower sides of the sheet re-feeding roller 28. The sheet re-feeding roller 28 is configured to be able to rotate in forward and backward directions. When a sheet is re-fed from the sheet re-feeding path 62, the sheet re-feeding roller 28 is driven to rotate in an anti-clockwise direction in FIG. 1. When a sheet is fed from the manual sheet feeding tray 33, the sheet re-feeding roller 28 is driven to rotate in a clockwise direction in FIG. 1.

Next, an image forming operation of the full color printer 100 according to the exemplary embodiment of the present invention is briefly described below.

The photoconductor drums 1 in the image forming units 10 are driven by a drive mechanism (not shown) to rotate in the clockwise direction, and surfaces of the photoconductor drums 1 are evenly charged by the chargers to a predetermined polarity. The charged surfaces are irradiated with laser light emitted from an optical writing apparatus 14 so as to form respective electrostatic latent images thereon. The laser light represents image information of four colors including magenta, cyan, yellow, and black obtained by separating a desired full color image. The electrostatic latent images are supplied with toner in the respective colors and are visualized as respective toner images by the development units.

The intermediate transfer belt 11 is driven to rotate in the anti-clockwise direction as indicated by an arrow X in FIG. 1. In the image forming units 10, the respective toner images are sequentially transferred from the respective photoconductor drums 1, and are superimposed one after another onto the intermediate transfer belt 11 by action of the transfer rollers 12. As a result, the intermediate transfer belt 11 bears a full color toner image on a surface thereof.

A single color image may be formed by using any one of the image forming units 10. A bicolored or tricolored image may also be formed by using the image forming units 10. In a case of monochrome printing, the image forming unit 10Bk, typically located rightmost among the four image forming units 10 as shown in FIG. 1, is used for image forming.

Residual toner adhering to the surfaces of the photoconductor drums 1 after toner images are transferred is removed from the surfaces by using the cleaning mechanisms. Then, the surfaces are initialized by action of dischargers to prepare for forming a next image.

In the meantime, a sheet is fed from one of the sheet feeding cassettes 15a and 15b, or the manual sheet feeding tray 33, and is sent out by the pair of registration rollers 18 into a secondary transfer position in synchronization with conveyance of the toner image born on the intermediate transfer belt 11. Since the secondary transfer roller 19 is charged with transfer voltage opposite to a toner charge polarity of the toner image formed on the surface of the intermediate transfer belt 11, the toner image is transferred onto the sheet. When the sheet having the transferred toner image passes by the fixing unit 20, the toner image is molten and fixed to the sheet by heat and pressure. The sheet having the fixed image is discharged by the pair of sheet discharge rollers 29 onto the sheet discharge tray 30. A sheet conveyance path for single-sided image forming (in a case a sheet is fed from one of the sheet feeding cassettes 15a and 15b) is indicated by a solid line P1 in FIG. 2.

An optional sheet discharge tray may be mounted on the upper face of the full color printer 100 above the second switch pawl 22, and the sheet having the fixed image may be discharged onto the optional sheet discharge tray. An example of the optional sheet discharge tray is a four-bin tray (not shown) having a sort function. A sheet conveyance path for discharging a sheet onto the optional sheet discharge tray (after passing through the fixing unit 20) is indicated by a broken line P2 in FIG. 2.

When double-sided image forming is performed, the positions of the first to third switch pawls 21 to 23 are properly switched so that a sheet having a toner image fixed on one side thereof is conveyed into the switchback conveyance path 61. In this case, the first and second switch pawls 21 and 22 are positioned as indicated by the dotted lines in FIG. 2. The third switch pawl 23 is positioned as indicated by the solid line in FIG. 2. Further, the pairs of first and second reverse rollers 31 and 32 are driven to rotate in the forward direction, in other words, the clockwise direction in FIG. 1. A conveyance path for conveying the sheet into the switchback conveyance path 61 (beyond the pair of conveyance rollers 25) is indicated by a chain double-dashed line P3 in FIG. 2.

When a sensor 40 detects a rear end of the sheet conveyed into the switchback conveyance path 61, the pairs of first and second reverse rollers 31 and 32 are driven to rotate in the backward direction, in other words, the anti-clockwise direction in FIG. 1 so that the sheet is switched back. In the case, the third switch pawl 23 is switched into the position indicated by the dotted line in FIG. 2 so that the switched back sheet is conveyed into the sheet re-feeding path 62.

The sheet re-feeding path 62 meets at a lower end thereof of the sheet conveyance path extending from the manual sheet feeding tray 33, and further meets at an opposite side of the sheet re-feeding roller 28, the sheet conveyance path extending from the sheet feeding cassettes 15a and 15b. The sheet is conveyed in the sheet re-feeding path 62 by the pairs of conveyance rollers 26 and 27, and then toward the pair of registration rollers 18 by the sheet re-feeding roller 28. The sheet conveyance path passing through the sheet re-feeding path 62 (ranging from the third switch pawl 23 to a meeting point with the solid line P1) is indicated by an alternate long and short dashed line P4 in FIG. 2. The sheet conveyance path for feeding a sheet from the manual sheet feeding tray 33 (up to a position beyond the sheet re-feeding roller 28) is indicated by a dashed line P5 in FIG. 2.

The sheet switched back by using the switchback conveyance path 61 is supplied into the sheet re-feeding path 62 so that the sheet is reversed. A toner image is transferred from the intermediate transfer belt 11 onto another side of the sheet, and the transferred image is fixed by the fixing unit 20. The sheet having the images formed on both sides thereof is discharged onto one of the sheet discharge tray 30 and the optional sheet discharge tray to complete double-sided image forming.

Next, an adjustment of an image forming position according to the exemplary embodiment of the present invention is described below. An image forming position is represented as a relative position between a sheet and an image thereon. In detail, a relative position between a left edge of a side of a sheet and a left edge of an image formed on the side of the sheet is referred to as an image forming position. When a left edge of an image is located in the main scanning direction (hereinafter, referred to as a direction A) relative to a left edge of a sheet, a relative position between the image and the sheet has a positive value. On the other hand, when a left edge of an image is located in a direction opposite to the main scanning direction (hereinafter, referred to as a direction B) relative to a left edge of a sheet, a relative position between the image and the sheet has a negative value.

A proper position of an image to be formed on a first side of a sheet is referred to as a first proper image position. A proper position of an image to be formed on a second side of a sheet is referred to as a second proper image position.

A position in which an image is actually formed is referred to as an actual image position. When an adjustment is performed, an image is formed in an adjusted position. A position in which an image is formed according to an adjustment is referred to as an adjusted image position.

According to an exemplary embodiment of the present invention, when an adjustment of an image forming position needs to be made, a user or a serviceman operates the full color printer 100 to perform double-sided image forming by using a reference image. Sheets are fed from the respective sheet feeding trays for double-sided image forming, and the user or the serviceman checks respective positions of the reference images formed on two sides of the sheets.

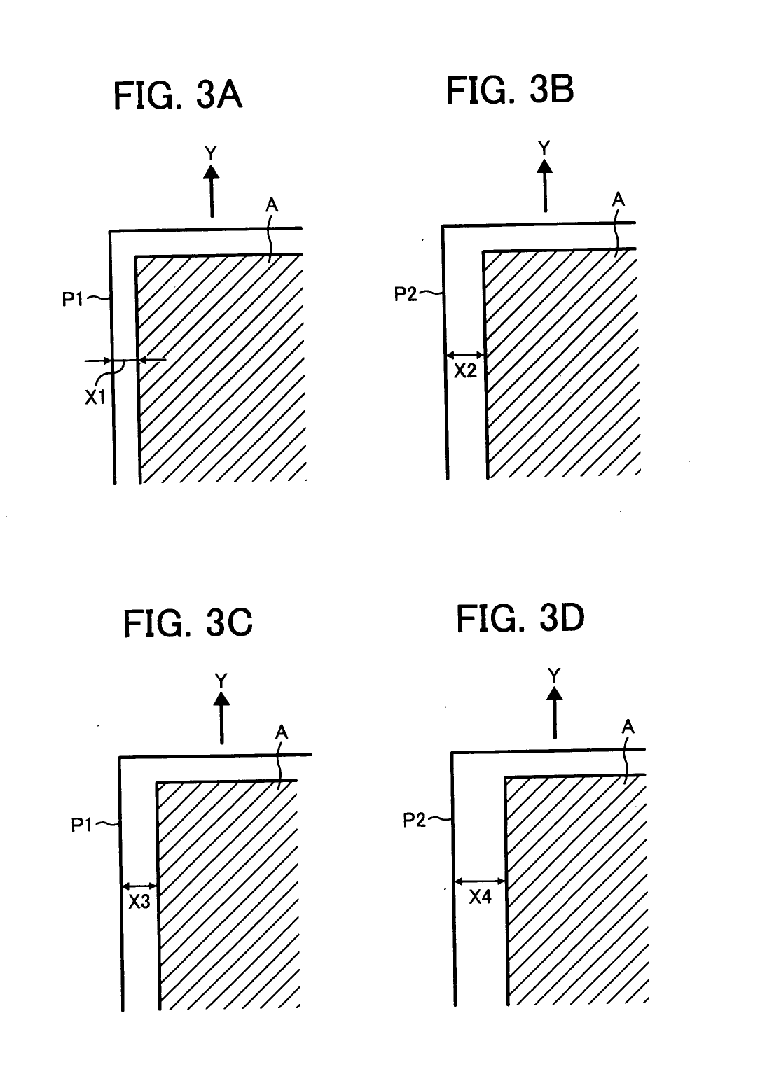

FIGS. 3A, 3B, 3C, and 3D illustrate exemplary variations in actual image positions attributed to lateral shifts of sheets. For example, when the first proper image position is equal to the second proper image position, and is 2 mm, a left edge of an image is properly located 2 mm off an edge of a sheet in the direction A. The full color printer 100 performs double-sided image forming on first and second sides of a sheet P1 fed from the sheet feeding cassette 15a (hereinafter, referred to as a first feeding tray) and a sheet P2 fed from the sheet feeding cassette 15b (hereinafter, referred to as a second feeding tray).

The sheets P1 and P2 are conveyed in a direction of an arrow Y. An actual image position is represented by a relative position between one of the sheets P1 and P2 and an image area A.

As shown in FIG. 3A, when the sheet P1 is fed for image forming on the first side thereof, and no shift occurs, an actual image position on the first side of the sheet P1 (hereinafter, referred to as X1) is 2 mm.

As shown in FIG. 3B, when the sheet P2 is fed for image forming on the first side thereof, and the sheet P2 shifts, for example, 1 mm in the direction B, an actual image position on the first side of the sheet P2 (hereinafter, referred to as X2) is 3 mm.

As shown in FIG. 3C, when the sheet P1 is fed for image forming on the second side thereof, and the sheet P1 shifts, for example, 1 mm in the direction B, an actual image position on the second side of the sheet P1 (hereinafter, referred to as X3) is 3 mm.

As shown in FIG. 3D, when the sheet P2 is fed for image forming on the second side thereof, and the sheet P2 shifts, for example, 2 mm in the direction B, an actual image position on the second side of the sheet P2 (hereinafter, referred to as X4) is 4 mm.

As described above, shifts occurred when sheets are fed for image forming result in variations in actual image positions. The variations in the actual image positions on the two sides of the sheets P1 and P2 in the above example may be corrected by the following adjustment values ΔX1, ΔX2, ΔX3, and ΔX4 (differences derived by subtracting the actual image positions from the proper image position):
ΔX1=0 mm;
ΔX2=−1 mm;
ΔX3=−1 mm; and
ΔX4=−2 mm.

In a related art apparatus, a single adjustment value is provided for correcting image positions in double-sided image forming, and the same adjustment value is applied to sheets fed from all sheet feeding trays.

In an exemplary embodiment of the present invention, when image forming is performed on first sides of sheets fed from the respective sheet feeding trays, correction values for the respective first sides are derived by subtracting the actual image positions on the respective first sides from the proper image position. When image forming is performed on second sides of the sheets fed from the respective sheet feeding trays, corrections values for the respective second sides are derived by subtracting the actual image positions on the respective second sides from the actual image positions on the respective first sides. Corrections are made by using the respective correction values for the first sides added with the respective correction values for the second sides. In an exemplary embodiment of the present invention, image positions on first and second sides in double-sided image forming are configured to be adjustable for each of the plurality of sheet feeding trays.

FIG. 4 is a block diagram illustrating a part of an exemplary configuration of a control unit included in the full color printer 100 related to an adjustment of an image forming position according to an exemplary embodiment of the present invention. As shown in FIG. 4, the control unit includes a control mechanism 51, a memory mechanism 52, a writing mechanism 53, and an operation unit 54. The operation unit 54 includes an input mechanism 55 and a display mechanism 56.

The control mechanism 51 includes a CPU and other components, such as an ASIC, a ROM, and a RAM, and controls each unit included in the body 50 of the full color printer 100. The memory mechanism 52 includes a memory, such as a NVRAM, and stores a correction value for correcting an image forming position for each of the sheet feeding trays. The writing mechanism 53 corresponds to the optical writing unit 14 shown in FIG. 1. The operation unit 54 corresponds to an operation panel of the full color printer 100 or an external computer connected to the full color printer 100. The full color printer 100 includes an image position adjustment mode. Selection between the image position adjustment mode and a normal mode is performed by using the input mechanism 55. Alternatively, the selection may be performed through a printer setting window of an external computer. A correction value is input by using the input mechanism 55 of the operation unit 54. Alternatively, a correction value may be input through a printer setting window of an external computer.

As described above referring to FIGS. 3A to 3D, the user or the service man obtains the actual image positions X1 to X4. Then, in order to obtain correction values δX1 and δX2 for the first sides of the sheets P1 and P2, respectively, the actual image positions X1 and X2 are compared with the first proper image position. Further, in order to obtain correction values δX3 and δX4 for the second sides of the sheets P1 and P2, respectively, the actual image positions X1 and X2 are compared with the actual image positions X3 and X4, respectively. Next, the correction values δX1 to δX4 are input when the full color printer is in the image position adjustment mode.

In the example in which the proper image position is 2 mm, and the actual image positions X1 to X4 are such that X1=2 mm, X2=3 mm, X3=3 mm, and X4=4 mm, the correction values δX1, δX2, δX3 and δX4 are derived as follows:
δX1=2−2=0 mm;
δX2=2−3=−1 mm;
δX3=X1−X3=2−3=−1 mm; and
δX4=X2−X4=3−4=−1 mm.

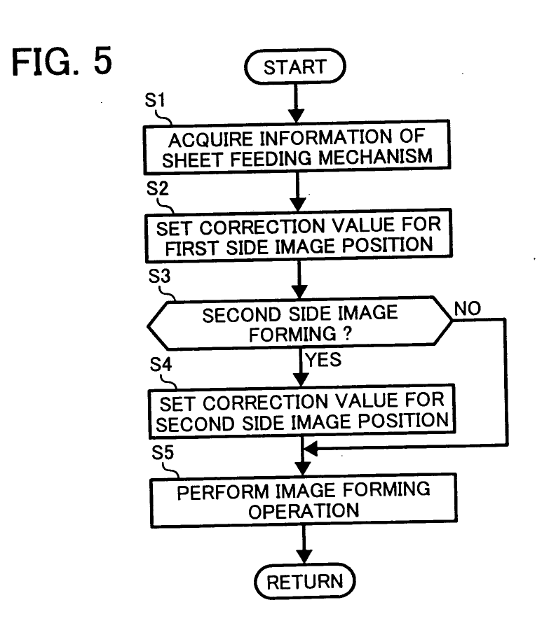

When the correction values δX1 to δX4 are input, the correction values are stored in the memory mechanism 52. Then, the control mechanism 51 controls the writing mechanism 53 in succeeding image forming so that images are formed in adjusted image positions. Detailed procedures for forming images in adjusted image positions are indicated in a flowchart shown in FIG. 5.

As shown in FIG. 5, when an image forming operation is started, the control mechanism 51 acquires information of the sheet feeding mechanism including a designated sheet feeding tray (step S1). Then, the control mechanism 51 reads from the memory mechanism 52 a correction value for adjusting an image position on a first side of a sheet fed from the designated sheet feeding tray, and sets the correction value (step S2). Next, a judgment is made on whether or not image forming to be performed is on a second side of a sheet (step S3). When the image forming to be performed is not on the second side (No in step S3), step S5 is performed, in which image forming is performed by controlling the writing mechanism 53 according to the set correction value. The case corresponds to first-side image forming for singe-sided image forming or double-sided image forming.

On the other hand, when the image forming to be performed is on the second side (Yes in step S3), step S4 is performed, in which, the control mechanism 51 reads from the memory mechanism 52 a correction value for adjusting an image position on a second side of the sheet fed from the designated sheet feeding tray, and sets the correction value. In other words, the correction value for the first-side image forming is added with the correction value for the second-side image forming. Then, image forming is performed by controlling the writing mechanism 53 according to the set correction values (step S5).

In order for the full color printer 100 including the four image forming units 10M, 10C, 10Y, and 10Bk for four colors to correct an image forming position, the image forming unit 10Bk, typically located at a downstream end among the four image forming units in the rotation direction of the intermediate transfer belt 11 as indicated by the arrow X in FIG. 1, may serve as a reference for the correction. In general, an adjustment of colors or positions being out of registration is made by using the black color as a reference in a full color image forming apparatus, and adjusting an image forming position in double-sided image forming by using the black color as a reference. Therefore, adjusting image forming positions for other colors accordingly may better correct colors and positions being out of registration in second-sided image forming.

In an exemplary embodiment of the present invention, as any extra components need not be added, high quality image in which variations in image forming positions in double-sided image forming are corrected may be provided at low cost.

Further, since the full color printer 100 includes the memory mechanism for storing a correction value input from the operation panel of the full color printer 100 or an external computer, a correction is automatically made in succeeding image forming, and image forming positions may be easily corrected.

It may be defined that a difference between image forming positions on first and second sides of one sheet in double-sided image forming is consistent among a plurality of sheet feeding trays. Therefore, according to an exemplary embodiment of the present invention, when image forming is performed on a second side of a sheet in double-sided image forming, a correction value for the second side is added to a correction value for a first side of the sheet. As a result, images are formed in consistent image forming positions so that high quality image forming is performed.

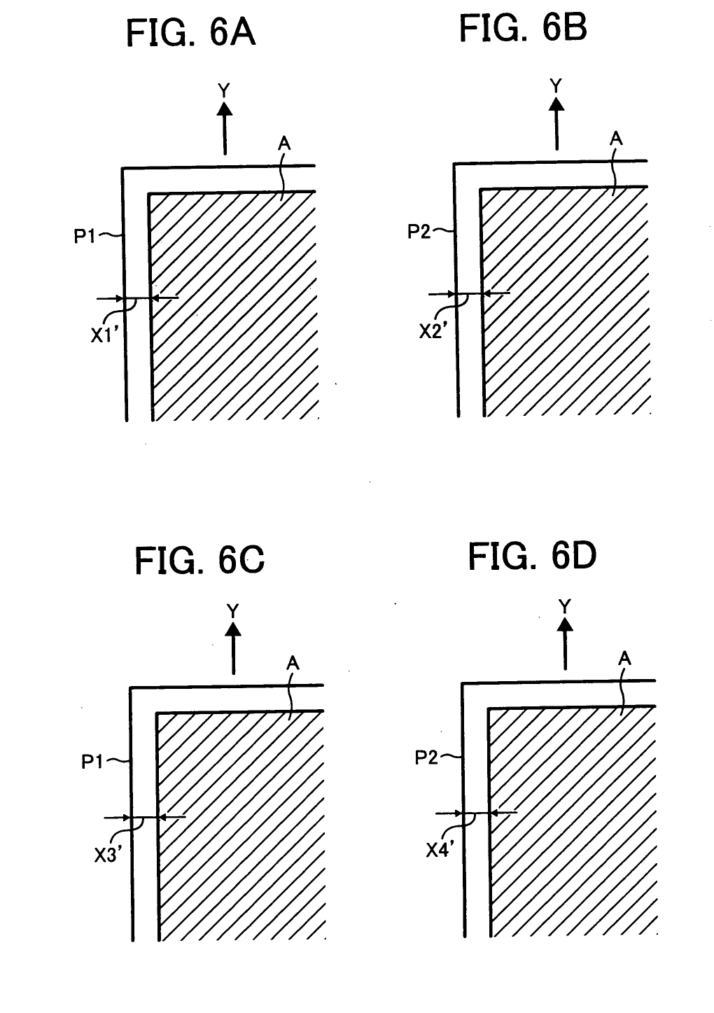

FIGS. 6A, 6B, 6C, and 6D are schematic illustrations of image forming positions adjusted by using correction values for the respective sheet feeding trays when double-sided image forming is performed according to an exemplary embodiment of the present invention.

As in FIGS. 3A to 3D, the sheets P1 and P2 are conveyed in the direction of the arrow Y. An adjusted image position is represented by a relative position between one of the sheet P1 and P2 and the image area A.

When the actual image positions are such that: X1=2 mm; X2=3 mm; X 3=3 mm; and X4=4 mm, the following correction values: δX1=0 mm; δX2=−1 mm; δX3=−1 mm; and δX4=−1 mm are input. As a result, adjusted image positions X1′, X2′, X3′, and X4′ in succeeding image forming are such that:
X1′=X1+δX1=2+0=2 mm;
X2′=X2+δX2=3−1=2 mm;
X3′=X3+δX1+δX3=3+0−1=2 mm; and
X4′=X4+δX2+δX4=4−1−1=2 mm.

The image forming positions on the first and second sides are consistent for all the sheet feeding trays.

Another exemplary variation in actual image positions are described below. In the case, the first proper image position is equal to the second proper image position, and is 2 mm as in the above case.

When the actual image positions are such that: X1=3 mm; X2=2 mm; X3=5 mm; and X4=4 mm, the correction values δX1 to δX4 are derived as follows:
δX1=2−3=−1 mm;
δX2=2−2=0 mm;
δX3=X1−X3=3−5=−2 mm; and
δX4=X2−X4=2−4=−2 mm.

Adjusted image positions after the correction values are input are such that:
X1′=X1+δX1=3−1=2 mm;
X2′=X2+δX2=2+0=2 mm;
X3′=X3+δX1+δX3=5−1−2=2 mm; and
X4′=X4+δX2+δX4=4+0−2=2 mm.

The image forming positions on the first and second sides are consistent for all the sheet feeding trays.

Next, another exemplary embodiment of the present invention is described below, in which a calculation method of a correction value for a second side is different from the calculation method in the above exemplary embodiment. The calculation method may be used even when the first proper image position is not equal to the second proper image position. In the exemplary embodiment, a correction value for a second side is derived by subtracting an actual image position on the second side from the second proper image position, and an adjustment is made by using the correction value.

When the second proper image position is 2 mm, and actual image positions on second sides of sheets are such that: X3=3 mm; and X4=4 mm, correction values εX3 and εX4 to be input are such that:
εX3=2−X3=2−3=−1 mm; and
εX4=2−X4=2−4=−2 mm.

As a result, adjusted image positions are such that:
X3′=X3+εX3=3−1=2 mm; and
X4′=X4+εX4=4−2=2 mm.

The image forming positions on the second sides are consistent for all the sheet feeding trays.

The present invention is described above referring to the drawings, but the present invention is not limited thereto.

For example, an adjustment may be made without using an image forming position. Alternatively, a registration roller may be configured to be able to move in the main scanning direction so that an amount of moving the registration roller may be controlled by using a correction value derived according to the above exemplary embodiments. As a result, a relative position between a sheet and an image thereon may be adjusted.

Further, an adjustment of a relative position between a sheet and an image thereon may be applied not only to first-side and second-side image forming in double sided image forming but also to composite printing on a single side of a sheet.

Further, the present invention may be applied to a monochrome image forming apparatus including a single image bearing member, and to a color image forming apparatus including a plurality of development units arranged around a single image bearing member. In addition, the present invention may be changed within a scope of the present invention, and may be applied not only to an image forming apparatus adopting an electronographic method, but also to a printer adopting an ink jet method or a dot method. An image forming apparatus is not limited to a printer. Alternatively, an image forming apparatus may be a copier, a facsimile, or a multifunction printer having a plurality of functions.

What is claimed:

1. An image forming apparatus, comprising:
an image forming mechanism configured to form an image on a recording medium;
a re-feeding mechanism configured to re-feed a recording medium having an image formed on a first side thereof to the image forming mechanism;
an adjustment mechanism configured to adjust a relative position between a recording medium and an image; and
a control mechanism configured to control the adjustment mechanism according to a first correction value derived by subtracting an actual image position on a second side of a recording medium from a predetermined position when second-side image forming is performed after first-side image forming is performed.

2. The image forming apparatus according to claim 1, wherein the predetermined position is an actual image position on a first side of the recording medium when proper image positions on the first and second sides thereof are the same.

3. The image forming apparatus according to claim 2, wherein the control mechanism controls the adjustment mechanism according to a value derived by adding the first correction value to a second correction value derived by subtracting the actual image position on the first side of the recording medium from the proper image position thereon.

4. The image forming apparatus according to claim 1, wherein the predetermined position is the proper image position on the second side of the recording medium.

5. The image forming apparatus according to claim 3, wherein the control mechanism controls the adjustment mechanism according to the second correction value when first-side image forming is performed.

6. The image forming apparatus according to claim 5, further comprising:
a plurality of sheet feeding trays having different paths each for conveying a recording medium to the image forming mechanism.

7. The image forming apparatus according to claim 6, wherein the control mechanism is configured to store the first and second correction values for each of the plurality of sheet feeding trays, and to control the adjustment mechanism according thereto.

8. The image forming apparatus according to claim 7, further comprising:
an image bearing member, wherein the adjustment of a relative position between a recording medium and an image thereon is performed by adjusting a position in which an image is formed on the image bearing member.

9. The image forming apparatus according to claim 8, further comprising:
a plurality of image forming units including at least a black image forming unit configured to form a black color image, wherein the adjustment of a relative position between a recording medium and an image thereon is performed by using the black image forming unit as a reference to adjust the other image forming units.

10. The image forming apparatus according to claim 8, further comprising:
a registration mechanism configured to synchronize conveyance timing of an image formed on the image bearing member and a recording medium, wherein the registration mechanism is configured to be movable along a main scanning direction, and the adjustment of a relative position between a recording medium and an image thereon is performed by moving the registration mechanism in the main scanning direction.

11. The image forming apparatus according to claim 9, further comprising:
an intermediate transfer member, wherein the plurality of image forming units are arranged side by side in a line opposed to the intermediate transfer member, and the image forming apparatus is configured to form color images with a tandem method.

12. The image forming apparatus according to claim 7, further comprising:
an input mechanism for inputting the first and second correction values for each of the plurality of sheet feeding trays.

13. The image forming apparatus according to claim 12, wherein the image forming apparatus is connected to an external apparatus, and the external apparatus is configured to serve as the input mechanism.

14. The image forming apparatus according to claim 12, further comprising:
a memory mechanism storing the first and second correction values for each of the plurality of sheet feeding trays input by using the input mechanism, wherein, in succeeding image forming, the input correction values are read from the memory mechanism and are used for the adjustment of a relative position between a recording medium and an image thereon.

15. The image forming apparatus according to claim 7, wherein the image forming apparatus is configured to form images with an ink jet method, and the adjustment of a relative position between a recording medium and an image thereon is performed by controlling a position in which printing is performed on the recording medium.
